(19) United States
(12) Patent Application Publication
(10) Pub. No.: US 2019/0193064 A1
(43) Pub. Date: Jun. 27, 2019

(54) IRON-BASED CATALYST FOR FISCHER-TROPSCH SYNTHESIS, METHOD OF PREPARING THE SAME AND METHOD OF USING THE SAME

(71) Applicant: WUHAN KAIDI ENGINEERING TECHNOLOGY RESEARCH INSTITUTE CO., LTD., Wuhan (CN)

(72) Inventors: Li GUO, Wuhan (CN); Jiangang CHEN, Wuhan (CN); Yanfeng ZHANG, Wuhan (CN); Jiaqi JIN, Wuhan (CN); Youliang SHI, Wuhan (CN); Shenke ZHENG, Wuhan (CN); Yan GONG, Wuhan (CN)

(21) Appl. No.: 16/288,063

(22) Filed: Feb. 27, 2019

Related U.S. Application Data
(63) Continuation-in-part of application No. PCT/CN2017/094223, filed on Jul. 25, 2017.

(30) Foreign Application Priority Data
Aug. 31, 2016 (CN) 201610785839.X

(51) Int. Cl. B01J 35/00; C10G 2/00; B01J 23/745; B01J 35/10; B01J 35/08

(52) U.S. Cl. CPC B01J 35/0006; C10G 2/332; B01J 23/745; C10G 2300/70; B01J 35/1061; B01J 35/08; B01J 35/0046

(57) ABSTRACT

A catalyst, including silica and iron. The silica is in the form of a mesoporous spherical particle. The iron is in the form of nanoparticles evenly distributed and encapsulated in the silica. The particle size of the silica is between 140 and 160 nm, and the silica includes pores between 2 and 9 nm in diameter.

### CROSS-REFERENCE TO RELATED APPLICATIONS

This application is a continuation-in-part of International Patent Application No. PCT/CN2017/094223 with an international filing date of Jul. 25, 2017, designating the United States, now pending, and further claims foreign priority benefits to Chinese Patent Application No. 201610785839.X filed Aug. 31, 2016. The contents of all of the aforementioned applications, including any intervening amendments thereto, are incorporated herein by reference. Inquiries from the public to applicants or assignees concerning this document or the related applications should be directed to: Matthias Scholl P. C., Attn.: Dr. Matthias Scholl Esq., 245 First Street, 18th Floor, Cambridge, Mass. 02142.

### BACKGROUND

This disclosure relates to the field of Fischer-Tropsch synthesis, and more particularly to an iron-based catalyst for Fischer-Tropsch synthesis, to a method of preparing the same, and to a method of using the same.

Conventional production processes of alpha-olefins include paraffin pyrolysis or ethylene oligomerization. The involved materials include wax or ethylene, both of which are non-renewable.

Fischer-Tropsch synthesis is a reaction that converts coal, natural gas, petroleum coke and other carbon-containing raw materials into alkanes, olefins, aldehydes, alcohols and organic acids. However, the reaction is not perfect; existing iron-based catalysts tend to aggregate and clump during the reaction resulting in decreased catalytic activity. Also, the stability of conventional catalysts and the selectivity for long-chain alpha-olefins leave much to be desired.

### SUMMARY

The disclosure provides an iron-based catalyst for Fischer-Tropsch synthesis and its preparation method and use. The iron-based catalyst is stable and exhibits relatively high selectivity for long chain alpha-olefins.

Disclosed is an iron-based catalyst for Fischer-Tropsch synthesis, the catalyst comprising silica and iron; the silica is in the form of mesoporous spherical particles; the iron is in the form of nanoparticles evenly distributed and encapsulated by the silica; the particle size of the silica is between 140 and 160 nm, and the silica comprises pores between 2 and 9 nm in diameter.

The iron can account for 5-40 wt. % of the catalyst, and the balance is the silica.

The particle size of the silica can be between 150 and 160 nm, and the pores of the silica can be between 2.1 and 5.7 nm in diameter.

The particle size of the silica can be between 150 and 155 nm, and the pores of the silica can be between 3.3 and 4.1 nm in diameter.

Also provided is a method of preparing the aforesaid catalyst, the method comprising:
1) mixing ethanol and water with a volume ratio of 1-10:1-10 to yield an ethanol water, adding 0.005-0.02 g/mL of an organic amine to the ethanol water, to yield a mixture;
2) adding iron nanoparticles to the mixture obtained in 1), followed by addition of 0.05-0.2 g/mL of tetraethyl orthosilicate, to yield a product;
3) placing the product in a 1-15 megapascal CO₂ atmosphere, heating to 35-45° C., allowing the reaction to take place, cooling, and releasing CO₂, to yield a solid product; and
4) washing the solid product obtained in 3) with water, and drying and calcining, to yield the catalyst.

In 3), the product can be placed in 6-9 megapascal CO₂ atmosphere, heated to 40-45° C., and stirred for 22-26 hours.

In 4), the calcining temperature can be 500-560° C., and the calcining time can be 4.5-5.5 hours.

In 2), the iron nanoparticles can account for 5-40 wt. % of the mixture.

A method of preparing alpha-olefin through Fischer-Tropsch synthesis, the method comprising introducing syngas as a material and the catalyst to a Fischer-Tropsch reactor. The reaction conditions in the Fischer-Tropsch reactor can be as follows: reaction temperature 190-360° C., reaction pressure 0.5-5.0 megapascal, space velocity 400-20000 h⁻¹ (V/V), stirring speed 400-1400 rpm, and H₂/CO=1-3:1 (V/V).

The method can further comprise reducing the catalyst in the presence of pure hydrogen or syngas under the following conditions: reduction temperature 300-350° C., reduction pressure 0.2-1.2 megapascal, stirring speed 400-1400 rpm, space velocity 400-3500 h⁻¹ (V/V), reaction time 6-18 h.

Advantages of the iron-based catalyst for Fischer-Tropsch synthesis, preparation method and use thereof as described in the disclosure are summarized as follows.

1. The reduction degree and carbonization degree of the catalyst is easy to control. The iron nanoparticles are encapsulated in the uniform spherical silicon dioxide carrier, which prevents the sintering of the iron nanoparticles and facilitates the formation of the active sites. The relatively large mesoporous is conducive to the diffusion of the molecules, thus improving the selectivity for alpha-olefins.

2. The morphology of the catalyst is regulated by the pressure of CO₂, and the CO₂ can also play the role of pore enlargement, thus no need to use the acid, alkali and organic pore enlargers, saving the production costs.

3. The iron-based catalyst can be formed by powder pressing or spray drying and exhibits good mechanical properties.

4. The monodisperse structure and the metal-carrier interaction of the catalyst facilitate the formation of the active center of the iron-based catalyst, so that the catalyst exhibits high selectivity for alpha-olefins.

5. The method uses carbon dioxide as a regulator, reduces the use of inorganic mineral acid. The process is environmentally friendly and develops a new use for carbon dioxide.

### BRIEF DESCRIPTION OF THE DRAWINGS

FIG. 1 is a SEM photo of an iron-based catalyst prepared without or with little CO₂ pressure according to one embodiment of the disclosure;

FIG. 2 is a SEM photo of an iron-based catalyst according to one embodiment of the disclosure; and

FIG. 3 is a TEM photo of an iron-based catalyst according to one embodiment of the disclosure.

### DETAILED DESCRIPTION

To further illustrate, embodiments detailing an iron-based catalyst for Fischer-Tropsch synthesis, preparation method and use thereof are described below. It should be noted that the following embodiments are intended to describe and not to limit the disclosure.

### Example 1

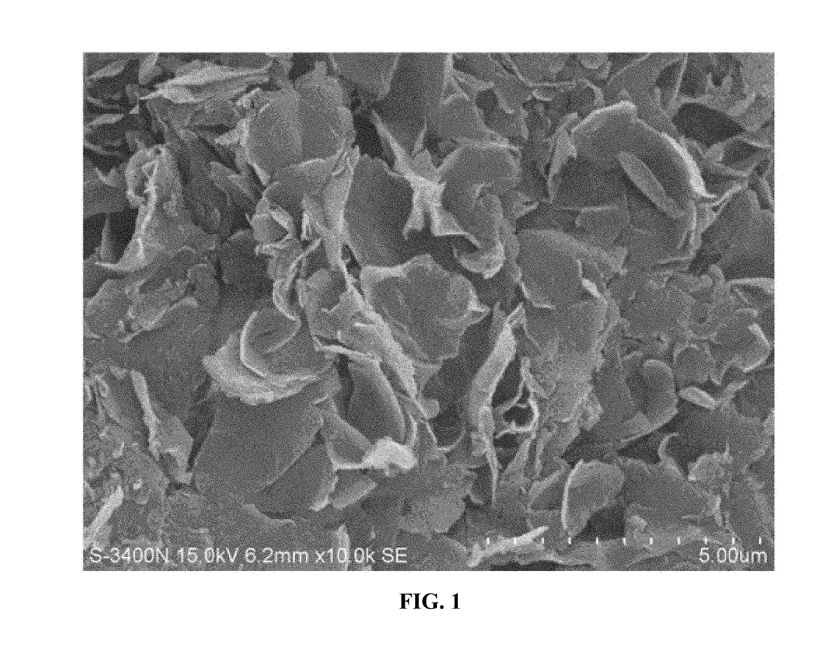

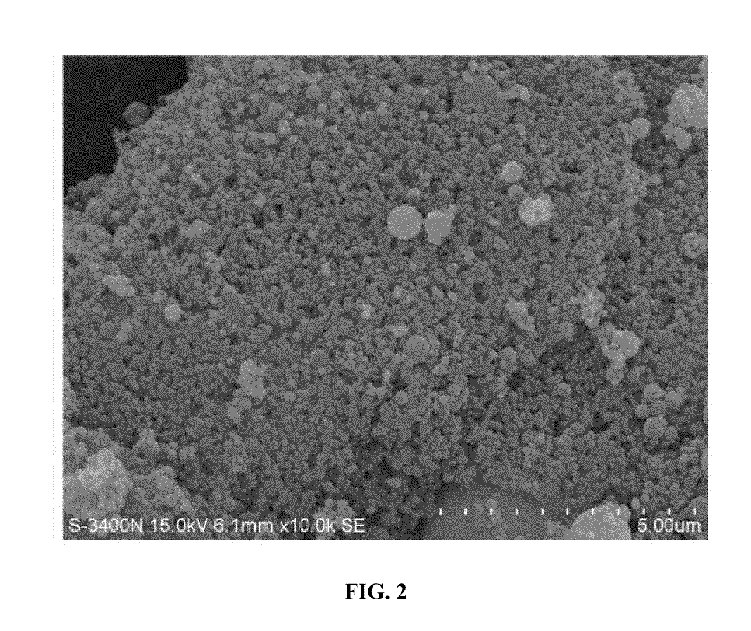

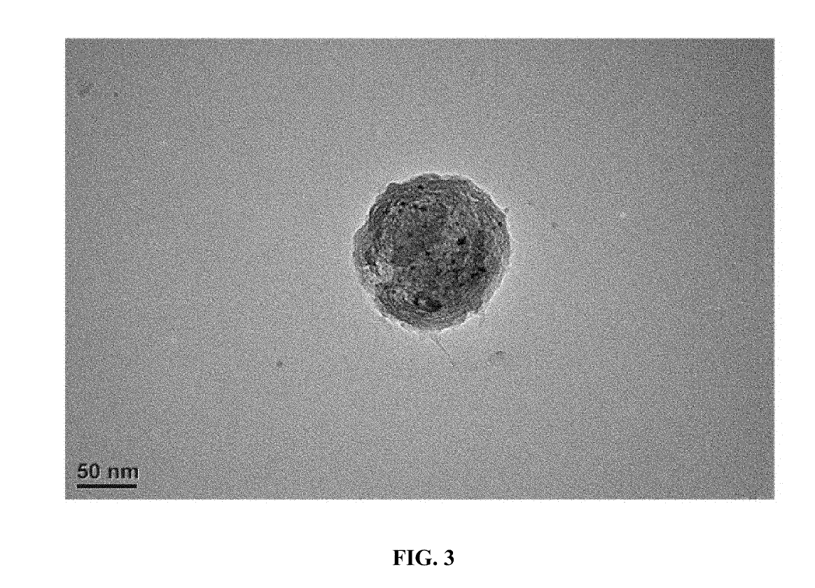

1.22 g of dodecylamine was added to a mixture of 10 mL of ethanol and 90 mL of water and stirred at room temperature for 1 h. Then 0.59 g of iron nanoparticles and 8.16 g of tetraethyl orthosilicate were added. The obtained mixture was transferred to a high-pressure reactor, CO₂ injected, heated to 40° C. and stirred for 24 h. The CO₂ pressure was 1.0 megapascal. Thereafter, the high-pressure reactor was cooled and the CO₂ released. The resulting solid was washed with water and suction filtered for several times, dried overnight, to yield a powder. The powder was calcined in a muffle furnace at 500° C. for 5 h, tableted, and sieved to yield a monodisperse iron-based catalyst comprising 20 wt. % of iron (20 wt % Fe@SiO₂—CO₂-1). With the increase of carbon dioxide, the catalyst is transformed from a disc-shaped lamination (shown in FIG. 1) to homogeneous spherical particles (shown in FIG. 2). The iron nanoparticles are encapsulated in the mesoporous spherical silica and distributed evenly. The particle size of the carrier silica is 150 nm, and the mesoporous diameter of the carrier silica is 2.5±0.4 nm (as shown in FIG. 3).

1.5 mL of 60-80 meshes of the prepared iron-based catalyst was added to a pressurized fixed-bed reactor (Φ10×500 mm) and reduced in pure hydrogen by temperature programmed reduction. The reduction conditions were as follows: reduction temperature 400° C., pressure 0.4 megapascal, space velocity 800 h⁻¹ (V/V), and time 12 h. After reduction, the synthesis gas was introduced to the reactor and the reaction conditions were as follows: temperature 260° C., pressure 1.0 megapascal, space velocity 400 h⁻¹ (V/V), H₂/CO=3/1 (V/V). The reaction results are shown in Table 2.

15 mL of more than 140 meshes of the prepared iron-based catalyst was added to a 1-L stirred slurry reactor, followed by addition of 500 mL of liquid wax. The resulting mixture was reduced in pure hydrogen by temperature programmed reduction. The reduction conditions were as follows: reduction temperature 400° C., pressure 0.4 megapascal, space velocity 600 h⁻¹ (V/V), stirring speed 600 rpm, and time 12 h. After reduction, the synthesis gas was introduced to the reactor and the reaction conditions were as follows: temperature 260° C., pressure 1.0 megapascal, space velocity 700 h⁻¹ (V/V), stirring speed 600 rpm, and H₂/CO=3/1 (V/V). The reaction results are shown in Table 2.

### Example 2

0.5 g of formamide was added to a mixture of 90 mL of ethanol and 10 mL of water and stirred at room temperature for 1 h. Then 0.34 g of iron nanoparticles and 5 g of tetraethyl orthosilicate were added. The obtained mixture was transferred to a high-pressure reactor, CO₂ injected, heated to 45° C. and stirred for 22 h. The CO₂ pressure was 4.0 megapascal. Thereafter, the high-pressure reactor was cooled and the CO₂ released. The resulting solid was washed with water and suction filtered for several times, dried overnight, to yield a powder. The powder was calcined in a muffle furnace at 560° C. for 4.5 h, tableted, and sieved to yield a monodisperse iron-based catalyst comprising 20 wt. % of iron (20 wt % Fe@SiO₂—CO₂-4). The particle size of the carrier silica is 155 nm, and the mesoporous diameter of the carrier silica is 3.7±0.4 nm.

1.5 mL of 60-80 meshes of the prepared iron-based catalyst was added to a pressurized fixed-bed reactor (Φ10×500 mm) and reduced in pure hydrogen by temperature programmed reduction. The reduction conditions were as follows: reduction temperature 300° C., pressure 1.2 megapascal, space velocity 3000 h⁻¹ (V/V), and time 12 h. After reduction, the synthesis gas was introduced to the reactor and the reaction conditions were as follows: temperature 260° C., pressure 5.0 megapascal, space velocity 400 h⁻¹ (V/V), H₂/CO=2/1 (V/V). The reaction results are shown in Table 2.

15 mL of more than 140 meshes of the prepared iron-based catalyst was added to a 1-L stirred slurry reactor, followed by addition of 500 mL of liquid wax. The resulting mixture was reduced in pure hydrogen by temperature programmed reduction. The reduction conditions were as follows: reduction temperature 300° C., pressure 1 megapascal, space velocity 600 h⁻¹ (V/V), stirring speed 600 rpm, and time 12 h. After reduction, the synthesis gas was introduced to the reactor and the reaction conditions were as follows: temperature 260° C., pressure 1.0 megapascal, space velocity 700 h⁻¹ (V/V), stirring speed 600 rpm, and H₂/CO=2/1 (V/V). The reaction results are shown in Table 2.

### Example 3

2 g of piperazine was added to a mixture of 10 mL of ethanol and 90 mL of water and stirred at room temperature for 1 h. Then 1.45 g of iron nanoparticles and 20 g of tetraethyl orthosilicate were added. The obtained mixture was transferred to a high-pressure reactor, CO₂ injected, heated to 35° C. and stirred for 26 h. The CO₂ pressure was 6.0 megapascal. Thereafter, the high-pressure reactor was cooled, and the CO₂ released. The resulting solid was washed with water and suction filtered for several times, dried overnight, to yield a powder. The powder was calcined in a muffle furnace at 540° C. for 5.5 h, tableted, and sieved to yield a monodisperse iron-based catalyst comprising 20 wt. % of iron (20 wt % Fe@SiO₂—CO₂-6). The particle size of the carrier silica is 160 nm, and the mesoporous diameter of the carrier silica is 4.6±0.4 nm.

1.5 mL of 60-80 meshes of the prepared iron-based catalyst was added to a pressurized fixed-bed reactor (Φ10×500 mm) and reduced in pure hydrogen by temperature programmed reduction. The reduction conditions were as follows: reduction temperature 500° C., pressure 0.2 megapascal, space velocity 800 h⁻¹ (V/V), and time 12 h. After reduction, the synthesis gas was introduced to the reactor and the reaction conditions were as follows: temperature 230° C., pressure 1.0 megapascal, space velocity 2000 h⁻¹ (V/V), H₂/CO=1/1 (V/V). The reaction results are shown in Table 2.

15 mL of more than 140 meshes of the prepared iron-based catalyst was added to a 1-L stirred slurry reactor, followed by addition of 500 mL of liquid wax. The resulting mixture was reduced in pure hydrogen by temperature programmed reduction. The reduction conditions were as follows: reduction temperature 400° C., pressure 0.4 megapascal, space velocity 600 h⁻¹ (V/V), stirring speed 600 rpm, and time 12 h. After reduction, the synthesis gas was introduced to the reactor and the reaction conditions were as follows: temperature 240° C., pressure 1.0 megapascal, space velocity 3000 h⁻¹ (V/V), stirring speed 600 rpm, and H₂/CO=1/1 (V/V). The reaction results are shown in Table 2.

### Example 4

1.5 g of aniline was added to a mixture of 10 mL of ethanol and 90 mL of water and stirred at room temperature for 1 h. Then 0.69 g of iron nanoparticles and 10 g of tetraethyl orthosilicate were added. The obtained mixture was transferred to a high-pressure reactor, CO₂ injected, heated to 40° C. and stirred for 24 h. The CO₂ pressure was 9.0 megapascal. Thereafter, the high-pressure reactor was cooled and the CO₂ released. The resulting solid was washed with water and suction filtered for several times, dried overnight, to yield a powder. The powder was calcined in a muffle furnace at 500° C. for 5 h, tableted, and sieved to yield a monodisperse iron-based catalyst comprising 20 wt. % of iron (20 wt % Fe@SiO₂—CO₂-9). The particle size of the carrier silica is 155 nm, and the mesoporous diameter of the carrier silica is 5.3±0.4 nm.

1.5 mL of 60-80 meshes of the prepared iron-based catalyst was added to a pressurized fixed-bed reactor (Φ10×500 mm) and reduced in pure hydrogen by temperature programmed reduction. The reduction conditions were as follows: reduction temperature 400° C., pressure 0.4 megapascal, space velocity 800 h⁻¹ (V/V), and time 12 h. After reduction, the synthesis gas was introduced to the reactor and the reaction conditions were as follows: temperature 240° C., pressure 1.0 megapascal, space velocity 800 h⁻¹ (V/V), H₂/CO=3/1 (V/V). The reaction results are shown in Table 2.

15 mL of more than 140 meshes of the prepared iron-based catalyst was added to a 1-L stirred slurry reactor, followed by addition of 500 mL of liquid wax. The resulting mixture was reduced in pure hydrogen by temperature programmed reduction. The reduction conditions were as follows: reduction temperature 400° C., pressure 0.4 megapascal, space velocity 600 h⁻¹ (V/V), stirring speed 600 rpm, and time 12 h. After reduction, the synthesis gas was introduced to the reactor and the reaction conditions were as follows: temperature 260° C., pressure 1.0 megapascal, space velocity 7000 h⁻¹ (V/V), stirring speed 600 rpm, and H₂/CO=3/1 (V/V). The reaction results are shown in Table 2.

### Example 5

0.61 g of laurylamine was added to a mixture of 10 mL of ethanol and 90 mL of water and stirred at room temperature for 1 h. Then 0.59 g of iron nanoparticles and 8.16 g of tetraethyl orthosilicate were added. The obtained mixture was transferred to a high-pressure reactor, CO₂ injected, heated to 40° C. and stirred for 24 h. The CO₂ pressure was 4.0 megapascal. Thereafter, the high-pressure reactor was cooled and the CO₂ released. The resulting solid was washed with water and suction filtered for several times, dried overnight, to yield a powder. The powder was calcined in a muffle furnace at 500° C. for 5 h, tableted, and sieved to yield a monodisperse iron-based catalyst comprising 20 wt. % of iron (20 wt % Fe@SiO₂—CO₂-4). The particle size of the carrier silica is 145 nm, and the mesoporous diameter of the carrier silica is 3.7±0.4 nm.

1.5 mL of 60-80 meshes of the prepared iron-based catalyst was added to a pressurized fixed-bed reactor (Φ10×500 mm) and reduced in pure hydrogen by temperature programmed reduction. The reduction conditions were as follows: reduction temperature 400° C., pressure 0.4 megapascal, space velocity 800 h⁻¹ (V/V), and time 12 h. After reduction, the synthesis gas was introduced to the reactor and the reaction conditions were as follows: temperature 260° C., pressure 1.0 megapascal, space velocity 12000 h⁻¹ (V/V), H₂/CO=3/1 (V/V). The reaction results are shown in Table 2.

15 mL of more than 140 meshes of the prepared iron-based catalyst was added to a 1-L stirred slurry reactor, followed by addition of 500 mL of liquid wax. The resulting mixture was reduced in pure hydrogen by temperature programmed reduction. The reduction conditions were as follows: reduction temperature 400° C., pressure 0.4 megapascal, space velocity 600 h⁻¹ (V/V), stirring speed 600 rpm, and time 12 h. After reduction, the synthesis gas was introduced to the reactor and the reaction conditions were as follows: temperature 230° C., pressure 1.0 megapascal, space velocity 1000 h⁻¹ (V/V), stirring speed 600 rpm, and H₂/CO=3/1 (V/V). The reaction results are shown in Table 2.

### Examples 6-10

Examples 6-10 are basically the same as that in Example 5 except the iron content of the iron-based catalyst, the CO₂ pressure, the reaction temperature, and the space velocity. The iron content of the iron-based catalyst and the CO₂ pressure are listed in Table 1. The reaction temperature, the space velocity, and the reaction results are shown in Table 2.

The iron content of the iron-based catalyst and the CO₂ pressure in the synthesis process in Examples 1-10 are listed in Table 1. In addition to the listed component, the rest is silica.

TABLE 1
Iron content of iron-based catalysts and CO₂ pressure
in the synthesis process in Examples 1-10

| Example | Fe content (wt. %) | CO₂ pressure (MPa) |
|---|---|---|
| Example 1 | 20% | 1 |
| Example 2 | 20% | 4 |
| Example 3 | 20% | 6 |
| Example 4 | 20% | 9 |
| Example 5 | 20% | 4 |
| Example 6 | 10% | 4 |
| Example 7 | 10% | 1 |
| Example 8 | 30% | 4 |
| Example 9 | 30% | 1 |
| Example 10 | 40% | 4 |

TABLE 2
Reactivity of iron-based catalysts of Examples 1-10 in olefin synthesis reaction

| Iron-based | | CO | C₁ | C₅+ | Olefin |
|---|---|---|---|---|---|
| catalysts | Reaction conditions | Conversion % | Selectivity % | Selectivity % | content % |
| Example 1 | 260° C., 400 h⁻¹ fixed-bed | 33.4 | 15.7 | 47.8 | 46.1 |
| | reactor | | | | |
| | 260° C., 700 h⁻¹ slurry | 38.4 | 15.8 | 46.5 | 35.9 |
| | reactor | | | | |
| Example 2 | 260° C., 400 h⁻¹ fixed-bed | 51.2 | 4.8 | 78.0 | 64.4 |
| | reactor | | | | |
| | 260° C., 700 h⁻¹ slurry | 40.8 | 5.2 | 77.6 | 65.1 |
| | reactor | | | | |
| Example 3 | 230° C., 2000 h⁻¹ fixed-bed | 41.3 | 6.1 | 75.2 | 61.6 |
| | reactor | | | | |
| | 240° C., 3000 h⁻¹ slurry | 32.9 | 5.8 | 76.2 | 63.5 |
| | reactor | | | | |
| Example 4 | 240° C., 800 h⁻¹ fixed-bed | 65.9 | 9.5 | 73.8 | 57.2 |
| | reactor | | | | |
| | 260° C., 7000 h⁻¹ slurry | 19.0 | 9.7 | 75.9 | 72.0 |
| | reactor | | | | |
| Example 5 | 260° C., 12000 h⁻¹ fixed-bed | 26.1 | 4.9 | 78.5 | 62.4 |
| | reactor | | | | |
| | 230° C., 1000 h⁻¹ slurry | 51.7 | 4.7 | 77.3 | 61.1 |
| | reactor | | | | |
| Example 6 | 240° C., 6000 h⁻¹ fixed-bed | 28.1 | 7.6 | 75.2 | 63.9 |
| | reactor | | | | |
| | 250° C., 3000 h⁻¹ slurry | 42.6 | 7.1 | 79.4 | 63.2 |
| | reactor | | | | |
| Example 7 | 240° C., 6000 h⁻¹ fixed-bed | 28.0 | 5.7 | 80.0 | 61.4 |
| | reactor | | | | |
| | 250° C., 3000 h⁻¹ slurry | 42.8 | 4.5 | 81.7 | 63.1 |
| | reactor | | | | |
| Example 8 | 240° C., 2000 h⁻¹ fixed-bed | 51.2 | 11.3 | 73.6 | 62.7 |
| | reactor | | | | |
| Example 9 | 330° C., 4000 h⁻¹ slurry | 30.3 | 6.8 | 51.9 | 70.3 |
| | reactor | | | | |
| Example 10 | 270° C., 4000 h⁻¹ slurry | 42.1 | 6.9 | 78.3 | 63.6 |
| | reactor | | | | |

It will be obvious to those skilled in the art that changes and modifications may be made, and therefore, the aim in the appended claims is to cover all such changes and modifications.

What is claimed is:

1. A composition of matter, comprising silica and iron; wherein:
the silica is in the form of a mesoporous spherical particle;
the iron is in the form of nanoparticles evenly distributed and encapsulated in the silica;
a particle size of the silica is between 140 and 160 nm; and
the silica comprises pores between 2 and 9 nm in diameter.

2. The composition of matter of claim 1, wherein the iron accounts for 5-40 wt. % of the composition of matter, and the balance is the silica.

3. The composition of matter of claim 1, wherein the particle size of the silica is between 150 and 160 nm, and the pores of the silica are between 2.1 and 5.7 nm in diameter.

4. The composition of matter of claim 2, wherein the particle size of the silica is between 150 and 160 nm, and the pores of the silica are between 2.1 and 5.7 nm in diameter.

5. The composition of matter of claim 1, wherein the particle size of the silica is between 150 and 155 nm, and the pores of the silica are between 3.3 and 4.1 nm in diameter.

6. The composition of matter of claim 2, wherein the particle size of the silica is between 150 and 155 nm, and the pores of the silica are between 3.3 and 4.1 nm in diameter.

7. A method for preparing a composition of matter, the method comprising:
1) mixing ethanol and water with a volume ratio of 1-10:1-10 to yield an ethanol water, adding 0.005-0.02 g/mL of an organic amine to the ethanol water, to yield a mixture;
2) adding iron nanoparticles to the mixture obtained in 1), followed by addition of 0.05-0.2 g/mL of tetraethyl orthosilicate, to yield a product;
3) placing the product in a 1-15 megapascal CO₂ atmosphere, heating to 35-45° C. for reaction, cooling, and releasing the CO₂, to yield a solid product; and
4) washing the solid product obtained in 3) with water, drying, calcining, to yield a composition of matter.

8. The method of claim 7, wherein in 3), the product is placed in 6-9 megapascal CO₂ atmosphere, heated to 40-45° C., and stirred for 22-26 hours.

9. The method of claim 7, wherein in 4), a calcining temperature is 500-560° C., and a calcining time is 4.5-5.5 hours.

10. The method of claim 8, wherein in 4), a calcining temperature is 500-560° C., and a calcining time is 4.5-5.5 hours.

11. The method of claim 7, wherein in 2), the iron nanoparticles account for 5-40 wt. % of the mixture.

12. The method of claim 8, wherein in 2), the iron nanoparticles account for 5-40 wt. % of the mixture.

13. A method of preparing an alpha-olefin, the method comprising introducing syngas and the composition of matter of claim 1 to a Fischer-Tropsch reactor, and subjecting them to reaction conditions as follows: reaction temperature 190-360° C., reaction pressure 0.5-5.0 megapascal, space velocity 400-20000 h⁻¹ (V/V), stirring speed 400-1400 rpm, and H₂/CO=1-3:1 (V/V).

14. The method of claim 13, further comprising reducing the composition of matter in the presence of pure hydrogen or syngas under the following conditions: reduction temperature 300-350° C., reduction pressure 0.2-1.2 megapascal, stirring speed 400-1400 rpm, space velocity 400-3500 h⁻¹ (V/V), reaction time 6-18 h.
